(19) United States
(12) Patent Application Publication
(10) Pub. No.: US 2026/0136127 A1
(43) Pub. Date: May 14, 2026

(54) EARPIECE AND EARPHONE

(71) Applicant: PANASONIC INTELLECTUAL PROPERTY MANAGEMENT CO., LTD., Osaka (JP)

(72) Inventors: Takashi KIHARA, Fukuoka (JP); Arata MIYAGI, Yamaguchi (JP); Haruhiko TOMURA, Fukuoka (JP)

(73) Assignee: PANASONIC INTELLECTUAL PROPERTY MANAGEMENT CO., LTD., Osaka (JP)

(21) Appl. No.: 19/385,883

(22) Filed: Nov. 11, 2025

(30) Foreign Application Priority Data
Nov. 13, 2024 (JP) 2024-198325

(51) Int. Cl. H04R 1/10

(52) U.S. Cl. CPC H04R 1/1058; H04R 1/1016

(57) ABSTRACT

An earpiece for an earphone includes a cylindrical base portion that is attached to a cylindrical sound conduit of an earphone main body. The base portion is formed of a three-layer structure including a first layer, a second layer, and a third layer, and the first layer, the second layer, and the third layer have different hardness. Also, an earphone includes the earpiece and an earphone main body.

### CROSS-REFERENCE TO RELATED APPLICATIONS

This application is based on and claims priority under 35 USC 119 from Japanese Patent Application No. 2024-198325 filed on November 13, 2024, the contents of which are incorporated herein by reference.

### TECHNICAL FIELD

The present invention relates to an earpiece and an earphone.

### BACKGROUND ART

Patent Literature 1 discloses, for example, an earpiece for an earphone, which is to be attached to a sound conduit (also referred to as "nozzle" or "port") of the earphone. The earpiece includes an upper skirt portion having an upper hollow tube and an upper umbrella surrounding a top end of the upper hollow tube, and a lower skirt portion having a lower hollow tube and a lower umbrella surrounding a top end of the lower hollow tube. A buffer portion communicating with the upper hollow tube is provided at the top end of the lower hollow tube, and the hardness of the lower skirt portion is slightly higher than the hardness of the upper skirt portion. It is disclosed that, according to this configuration, the lower skirt portion can seal an ear canal and the buffer portion can be appropriately bent, which assists the upper skirt portion to enter the ear canal, and eliminates a defect that the upper skirt portion hardly falls into or easily falls off from a deeper portion of the ear canal, thereby exhibiting an acoustic performance and quality of the earphone.

### CITATION LIST

### PATENT LITERATURE

Patent Literature 1: JP2018-042243A

### SUMMARY OF INVENTION

A sound (vibration) emitted from a driver passes through the sound conduit and is propagated to an eardrum through the earpiece, but some of the sound (vibration) may escape to the outside from between the sound conduit and the earpiece, that is, leak. From the viewpoint of the acoustic performance and quality of the earphone, it is necessary to prevent the above-described leakage of the sound (vibration) to the outside, but detailed studies have not been made on this point in Patent Literature 1.

The present disclosure has been made in view of the above-described situation in the related art, and an object of the present disclosure is to provide an earpiece and an earphone capable of preventing a sound (vibration) from leaking to the outside from between the earpiece and earphone and a sound conduit.

An earpiece according to the present disclosure is an earpiece for an earphone, and includes a cylindrical base portion that is attached to a cylindrical sound conduit of an earphone main body. The base portion is formed of a three-layer structure including a first layer, a second layer, and a third layer, and the first layer, the second layer, and the third layer have different hardness.

Further, an earphone of the present disclosure includes the earpiece and an earphone main body including a substantially cylindrical sound conduit to which the earpiece is attached.

According to the earpiece and earphone of the present disclosure, it is possible to prevent the sound (vibration) from leaking to the outside from between the earpiece and earphone and the sound conduit.

### BRIEF DESCRIPTION OF DRAWINGS

FIG. 1 is a schematic diagram illustrating an earphone including an earpiece according to Embodiment 1;

FIG. 2 is a schematic cross-sectional view of the earphone illustrated in FIG. 1; and

FIG. 3 is a schematic cross-sectional view of an earpiece according to an example in the related art.

### DESCRIPTION OF EMBODIMENTS

### Background of Present Disclosure

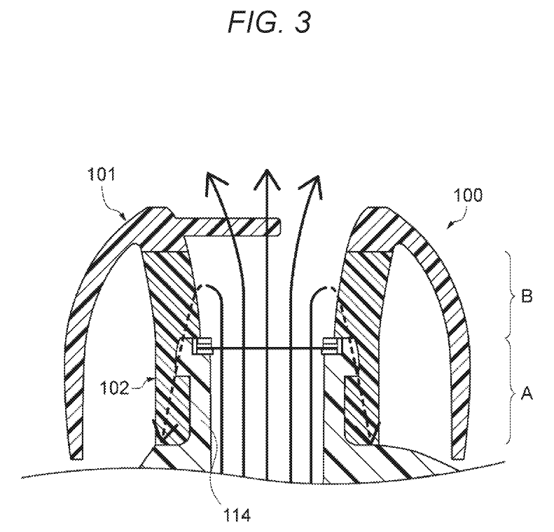

As illustrated in FIG. 3, an earpiece 100 in the related art is often formed of elastic materials having different hardness between a first portion 101 that enters a deeper portion of the ear canal and seals an ear canal and a second portion 102 excluding the first portion 101 (for example, see also Patent Literature 1). The hardness of the first portion 101 is set to be low in order to seal the ear canal, thereby enhancing the followability to the ear canal. On the other hand, since the second portion is formed of a region A attached to a sound conduit 114 and a region B that enters the inside of the ear hole, the setting of the hardness is complicated. Specifically, in the region A, high hardness is required so as to strongly adhere to the sound conduit 114, and in the region B, low hardness is required so as to achieve noise cancelling and comfort of a user because the region B enters the inside of the ear hole. When the hardness of the second portion 102 is increased with priority given to circumstances related to the region A, the followability to the ear canal and the sealability of the ear canal are impaired, and the user may feel uncomfortable with respect to the hardness of the second portion 102 sensed in the inside of the ear hole. On the other hand, when the hardness of the second portion 102 is reduced with priority given to circumstances related to the region B, the adhesion with the sound conduit 114 is reduced, and a sound (vibration) emitted from a driver may leak to the outside from between the second portion 102 and the sound conduit 114.

In Patent Literature 1, hardness of an upper skirt portion substantially corresponding to the first portion 101 illustrated in FIG. 3 is set to approximately A30° ± 5°, and hardness of a lower skirt portion substantially corresponding to the second portion 102 illustrated in FIG. 3 is set to approximately 40° ± 5°. In this case, the adhesion between the earpiece and the sound conduit is low, and the sound (vibration) away from the driver may leak to the outside from between the earpiece and the sound conduit.

In order to achieve both the noise cancelling and the comfort of the user, a wearing comfort of the earpiece to an ear of the user is important. Accordingly, in order to more appropriately achieve both the noise cancelling and the comfort of the user, it is necessary to improve the wearing comfort. Therefore, the "improvement of the wearing comfort" referred to in the present description includes a meaning of more appropriately achieving both the noise cancelling and the comfort of the user. When the wearing comfort is good, a sealed state of the earpiece to the ear canal is appropriately maintained, and thus the wearing comfort is improved, thereby improving the acoustic performance and quality of the earphone at the same time.

Hereinafter, embodiments of the present disclosure will be described in detail with reference to the drawings as appropriate. However, an unnecessarily detailed description may be omitted. For example, a detailed description of well-known matters and the redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matters described in the claims.

### Embodiment 1

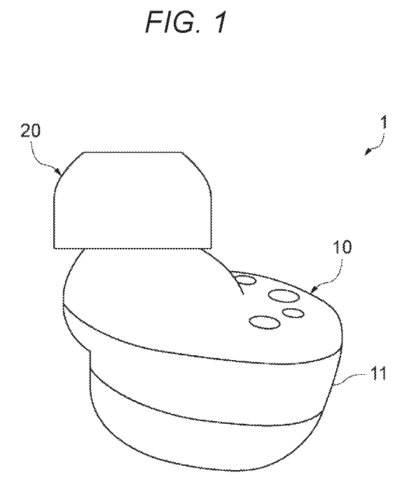

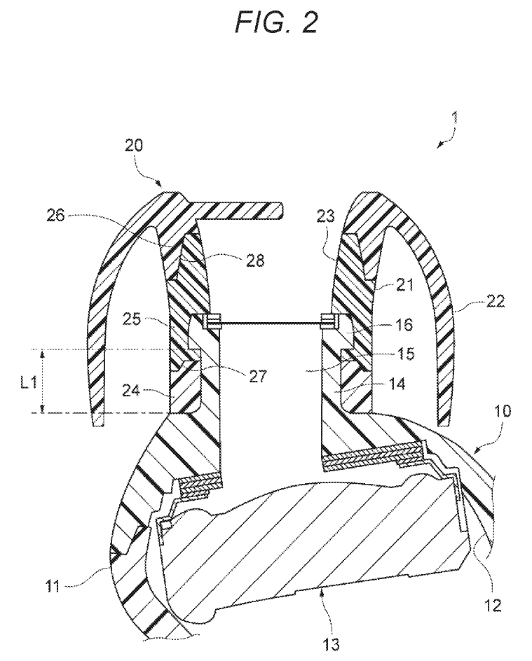

FIG. 1 is a schematic diagram illustrating an earphone 1 including an earpiece 20 according to Embodiment 1. FIG. 2 is a schematic cross-sectional view of the earphone illustrated in FIG. 1.

As illustrated in FIGS. 1 and 2, the earphone 1 includes an earphone main body 10 and the earpiece 20.

As illustrated in FIG. 2, the earphone main body 10 includes a housing 11 and a speaker unit 13. An inside of the housing 11 is an internal cavity 12, and the speaker unit 13 and the like are accommodated in the internal cavity 12.

The housing 11 is provided with the substantially cylindrical sound conduit 14 protruding therefrom, and the earpiece 20 is attached to the sound conduit 14. The sound conduit 14 has a sound outlet port 15 communicating with the internal cavity 12, and a sound (vibration) emitted from the speaker unit 13 is emitted to the earpiece 20 through the sound outlet port 15.

A retaining flange 16 for retaining the earpiece 20 is provided at a protruding end (upper end) of the sound conduit 14, and the retaining flange 16 is formed so as to expand in a diameter enlarging direction with respect to an outer peripheral surface of the sound conduit 14. That is, the retaining flange 16 is formed in a flange shape.

In the present description, unless otherwise specified, an upper side is a side (corresponding to upper side of paper surface) on which the sound passing through the sound conduit 14 is emitted from the sound outlet port 15, and a lower side is a side (corresponding to lower side of paper surface) on which the speaker unit 13 is accommodated.

The speaker unit 13 is a device that emits a sound (vibration), and is also referred to as a "driver", for example. A configuration of the speaker unit 13 is not particularly limited, and for example, a known speaker unit is used.

As illustrated in FIG. 2, the earpiece 20 integrally includes a base portion 21 and an skirt portion 22.

The base portion 21 is formed in a substantially cylindrical shape, and is provided with a through hole 23 penetrating through the base portion 21 over the entire region in the axial direction (up-down direction in drawing). By inserting the sound conduit 14 of the earphone main body 10 into the through hole 23, the earpiece 20 is attached to the sound conduit 14. Accordingly, the through hole 23 communicates with the sound outlet port 15, and thus the sound (vibration) emitted from the speaker unit 13 is emitted to the through hole 23 (earpiece 20) through the sound outlet port 15.

An inner diameter of the base portion 21 is equal to or smaller than an outer diameter of the sound conduit 14. Accordingly, in a state in which the earpiece 20 is attached to the sound conduit 14, an inner peripheral surface of the base portion 21 and the outer peripheral surface of the sound conduit 14 strongly adhere to each other.

The skirt portion 22 is connected to an upper end of the base portion 21 over the entire periphery thereof, and extends toward a lower end side of the base portion 21 so as to cover an outer periphery of the base portion 21. Accordingly, substantially the entire outer peripheral surface of the base portion 21 is covered with the skirt portion 22. The skirt portion 22 has a function of coming into contact with the ear canal of the user and sealing the ear canal in a state in which the user wears the earphone 1.

The earpiece 20 configured as described above is formed such that three types of elastic materials having different hardness form a layer.

In other words, the earpiece 20 includes a first layer 24 formed of an elastic material having highest hardness, a second layer 25 formed of an elastic material having hardness lower than that of the first layer 24, and a third layer 26 formed of an elastic material having hardness (lowest hardness) lower than that of the second layer 25, and these three layers are mainly laminated along the axial direction (up-down direction in drawing) of the base portion 21.

The elastic material is, for example, rubber such as silicone rubber. However, the elastic material is not limited thereto, and may be, for example, elastomer.

The first layer 24 is a layer mainly forming a lower side region of the base portion 21, and is a portion attached to the sound conduit 14 in the earpiece 20. Therefore, the hardness of the first layer 24 is set such that the sound (vibration) does not leak to the outside from between the first layer 24 and the sound conduit 14 from the viewpoint of improving the sound quality. Therefore, the hardness of the first layer 24 is preferably, for example, A70° or higher.

The second layer 25 is a layer mainly forming a central region of the base portion 21 between the first layer 24 and the third layer 26, a part of which is a portion attached to the sound conduit 14 (lower side portion in FIG. 2), and the other part is a portion to be inserted into the inside of the ear hole. Therefore, the second layer 25 is required to have a balance between improvement in sound quality and improvement in wearing comfort. Accordingly, the hardness of the second layer 25 is set in view of the above-described balance. Therefore, the hardness of the second layer is preferably, for example, about A55° ± 5°.

The third layer 26 is a layer mainly forming an upper side region of the base portion 21 and the skirt portion 22, and is a portion to be inserted into the inside of the ear hole to seal the ear canal. Therefore, the hardness of the third layer 26 is set from the viewpoint of improving the wearing comfort. Therefore, the hardness of the third layer 26 is preferably, for example, about A30° ± 5°.

As described above, since the earpiece 20 is formed such that three types of elastic materials having different hardness form a layer, a bonding boundary surface is formed between layers. Specifically, a first boundary surface 27 is formed between the first layer 24 and the second layer 25, and a second boundary surface 28 is formed between the second layer 25 and the third layer 26.

The first boundary surface 27 and the second boundary surface 28 are each formed in an uneven shape (for example, stepped shape) from the viewpoint of improving a bonding strength.

The first boundary surface 27 is set to be positioned between a base end of the sound conduit 14 and a lower end of the retaining flange 16 (within range of reference numeral L1 in FIG. 2) from the viewpoint of the attachment performance of the earpiece 20 to the sound conduit 14. However, when the position of the first boundary surface 27 is in the vicinity of the lower end of the retaining flange 16, a load is likely to be applied to the first boundary surface 27 at the time of attachment and detachment of the earpiece 20, and thus the first boundary surface 27 is preferably in a position away from the lower end of the retaining flange 16.

A position of the second boundary surface 28 is appropriately set such that a good wearing comfort is achieved in a state where the user wears the earphone 1.

As described above, the earpiece 20 is formed in a three-layer structure having different hardness. Accordingly, the hardness of a portion attached to the lower side of the sound conduit 14, that is, the first layer 24 can be set to be higher than that in the related art, and since the first layer 24 strongly adheres to the sound conduit 14, the sound (vibration) can be prevented from leaking to the outside from between the first layer 24 and the sound conduit 14. Accordingly, since the hardness of the second layer 25 can be flexibly set, improvement in sound quality and a good wearing comfort can be both achieved.

Further, in the earpiece 20, the first boundary surface 27 and the second boundary surface 28 are each formed in an uneven shape (for example, stepped shape). Accordingly, in the earpiece 20, each of an area of the bonding boundary surface between the first layer 24 and the second layer 25 and an area of the bonding boundary surface between the second layer 25 and the third layer 26 are is increased, as compared to a case where the first boundary surface 27 and the second boundary surface 28 each have a planar shape, for example, so that the bonding strength between adjacent layers, and consequently the strength of the earpiece 20 is excellent.

### Summary of Embodiment 1

The following techniques are disclosed based on the above description of Embodiment 1.

### Technique 1

An earpiece (20) for an earphone (1), including: a substantially cylindrical base portion (21) to be attached to a substantially cylindrical sound conduit (14) of an earphone main body (10), in which the base portion (21) is formed of a three-layer structure including a first layer (24), a second layer (25), and a third layer (26), and the first layer (24), the second layer (25), and the third layer (26) have different hardness.

According to this configuration, the hardness can be changed in accordance with a role required for each layer in the base portion. Specifically, in a layer in which strong adhesion to the sound conduit is required, by forming the layer with an elastic material having high hardness, it is possible to prevent a sound (vibration) from leaking to the outside from between the layer and the sound conduit. Further, according to the above-described configuration, the layer to be inserted into the inside of the ear hole is formed with an elastic material having low hardness, thereby achieving a good wearing comfort.

### Technique 2

The earpiece (20) according to technique 1, in which the first layer (24), the second layer (25), and the third layer (26) are laminated in this order from a sound conduit side (lower side in FIG. 2) in an axial direction of the base portion (21), and the hardness of the first layer (24) is higher than the hardness of the second layer (25), and the hardness of the second layer (25) is higher than the hardness of the third layer (26).

According to this configuration, the first layer can achieve strong adhesion to the sound conduit, and the third layer can achieve a good wearing comfort. In addition, the second layer achieves the hardness with balance, thereby more appropriately achieving both strong adhesion to the sound conduit and a good wearing comfort.

### Technique 3

The earpiece (20) according to technique 2, in which a first boundary surface (27) between the first layer (24) and the second layer (25) and a second boundary surface (28) between the second layer (25) and the third layer (26) each have an uneven shape.

According to this configuration, for example, as compared to a case where the boundary surface has a planar shape, each contact area between adjacent layers is increased, and thus the bonding strength between the adjacent layers and the strength of the base portion are excellent.

### Technique 4

The earpiece (20) according to technique 2 or 3, further including an skirt portion (22) connected to the base portion (21) and covering the base portion (21), in which hardness of the skirt portion (22) is equal to the hardness of the third layer (26). According to this configuration, the hardness of the third layer is equal to the hardness of the skirt portion, thereby achieving a better wearing comfort.

### Technique 5

An earphone (1) including: the earpiece (20) according to any of techniques 1 to 4; and an earphone main body (10) including a substantially cylindrical sound conduit (14) to which the earpiece (20) is attached.

According to this configuration, the acoustic performance and quality of the earphone are improved.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely within a range without departing from the gist of the invention.

### INDUSTRIAL APPLICABILITY

The technique of the present disclosure is useful for an earpiece attached to a sound conduit included in an earphone main body and an earphone including the above-described earpiece.

What is claimed is:

1. An earpiece for an earphone, comprising:
a cylindrical base portion that is attached to a cylindrical sound conduit of an earphone main body, wherein
the base portion is formed of a three-layer structure including a first layer, a second layer, and a third layer, and
the first layer, the second layer, and the third layer have different hardness.

2. The earpiece according to claim 1, wherein
the first layer, the second layer, and the third layer are laminated in this order from a sound conduit side in an axial direction of the base portion, and
the hardness of the first layer is higher than the hardness of the second layer, and the hardness of the second layer is higher than the hardness of the third layer.

3. The earpiece according to claim 2, wherein
a first boundary surface between the first layer and the second layer and a second boundary surface between the second layer and the third layer each have an uneven shape.

4. The earpiece according to claim 2, further comprising
an skirt portion connected to the base portion and covering the base portion, wherein
hardness of the skirt portion is equal to the hardness of the third layer.

5. An earphone comprising:
the earpiece according to claim 1; and
an earphone main body including a substantially cylindrical sound conduit to which the earpiece is attached.
